(19) United States
(12) Patent Application Publication
(10) Pub. No.: US 2012/0130841 A1
(43) Pub. Date: May 24, 2012

(54) SYSTEM AND METHOD FOR PROVIDING QUALIFICATION SEARCHING AND BIDDING FOR RENTAL PROPERTIES

(76) Inventor: Izaak Knight, Houston, TX (US)

(21) Appl. No.: 13/300,460

(22) Filed: Nov. 18, 2011

Related U.S. Application Data
(60) Provisional application No. 61/414,945, filed on Nov. 18, 2010.
(60) Provisional application No. 61/448,968, filed on Mar. 3, 2011.
(60) Provisional application No. 61/453,480, filed on Mar. 16, 2011.

(51) Int. Cl. G06Q 30/08

(52) U.S. Cl. 705/26.2

(57) ABSTRACT

A computer-implemented system and method for providing qualification searching and bidding for rental properties is disclosed. A potential renter can provide qualification information and desired features of a rental unit to a rental server to determine one or more rental communities for which the potential renter is qualified. The system and method further provide the potential renter to bid for a rental property with a plurality of rental communities.

### CROSS-REFERENCE TO RELATED APPLICATIONS

This application claims the benefit of U.S. Provisional Application No. 61/414,945, filed Nov. 18, 2010, U.S. Provisional Application No. 61/448,968, filed Mar. 3, 2011 and U.S. Provisional Application No. 61/453,480, filed Mar. 16, 2011. The disclosures of the above applications are incorporated herein by reference in their entirety.

### FIELD

The present disclosures is directed to a system and method for identifying and matching vendors with potential customers and customers with potential vendors and, more specifically, to a system and method for identifying and matching renters with potential rental properties and rental properties with potential renters.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The identification and matching of potential customers with potential vendors, and vice-versa, is an inefficient, time-consuming and expensive process. A vendor, in order to attract potential customers, may spend large sums of money for advertising in order to educate potential customers of the goods sold by the vendor. Additionally, a customer may spend a large amount of time individually contacting vendors to determine whether the vendor sells a specific good and, if so, if the vendor has the good “in stock” and ready for purchase. For infrequently purchased and/or specialized goods (goods sold by only a small number of vendors and/or of interest to only a small number of customers), these problems become more acute. For example only, a person interested in renting an apartment or other rental property (a “potential renter”) may spend countless hours/days searching for appropriate rental property. Similarly, a real estate community (a company or organization that leases rental property) may spend numerous hours meeting and negotiating with potential renters that are unable to afford, or are otherwise unqualified to rent, a specific rental property.

### SUMMARY

In various embodiments, the present disclosure relates to a computer-implemented method. The method can include receiving, at a computing device, a first user input corresponding to qualifications of a user with respect to a rental property. The method can also include accessing a plurality of rental property records from a storage database in communication with the computing device. Further, the method can include determining, at the computing device, one or more qualified rental properties based on the qualifications of the user and the plurality of rental property records. The one or more qualified rental properties can correspond to rental properties for which the user is qualified to rent based on the qualification. The method can additionally include providing, from the computing device, the one or more qualified rental properties to the user and receiving, at the computing device, a second user input corresponding to a selection of at least one of the one or more qualified rental properties to obtain one or more selected qualified rental properties. Also, the method can include receiving, at the computing device, a third user input corresponding to a rental bid for the one or more selected qualified rental properties, and providing, from the computing device, the rental bid and the qualifications of the user to at least one rental community user associated with the one or more selected qualified rental properties.

In various embodiments, the present disclosure relates to a computing system that can include a storage database, a processor a qualification module and a bidding module. The storage database can store a plurality of rental property records. Each of the rental property records can correspond to one of a plurality of rental properties. The processor can be in communication with the storage database and be configured to receive a first user input corresponding to qualifications of a user with respect to a rental property. The qualification module can be in communication with the processor and be configured to determine one or more qualified rental properties based on the qualifications of the user and the plurality of rental property records. The one or more qualified rental properties can correspond to rental properties for which the user is qualified to rent based on the qualifications. The bidding module can be in communication with the processor and be configured to: (i) receive a second user input corresponding to a selection of at least one of the one or more qualified rental properties to obtain one or more selected qualified rental properties, (ii) receive a third user input corresponding to a rental bid for at least one selected qualified rental property, and (iii) provide the rental bid and the qualifications of the user to at least one rental community user associated with the one or more selected qualified rental properties.

In various embodiments of the present disclosure, a computer-implemented method is disclosed. The method can include receiving, at a computing device, a first user input corresponding to qualifications of a user with respect to a rental property. The qualifications of the user can include a credit score of the user. The method can also include determining, at the computing device, a score of the user based on the first input, and receiving, at the computing device, a second user input corresponding to at least one feature of rental property desired by the user. The method can further include accessing a plurality of rental property records from a storage database in communication with the computing device. Additionally, the method can include determining, at the computing device, one or more qualified rental properties based on the qualifications of the user, the second user input and the plurality of rental property records. The one or more qualified rental properties can corresponding to rental properties for which the user is qualified to rent based on the qualifications. The determining of the one or more qualified rental properties can include comparing the score of the user to a threshold associated with each of the plurality of rental property records. The method can also include determining, at the computing device, one or more restrictions for each of the qualified rental properties based on the score of the user. The one or more restrictions can correspond to conditions upon which each of the one or more qualified rental properties will rent to the user. Further, the method can include providing, from the computing device, the one or more qualified rental properties and the one or more restrictions to the user and receiving, at the computing device, a third user input corresponding to a selection of at least one of the one or more qualified rental properties to obtain one or more selected qualified rental properties. The method also can include receiving, at the computing device, a fourth user input corresponding to a rental bid for the one or more selected qualified rental properties, and providing, from the computing device, the rental bid and the qualifications of the user to at least one rental community user associated with the one or more selected qualified rental properties.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an illustration of an example system for providing qualification searching and bidding for rental properties according to some embodiments of the present disclosure;

FIG. 2 is a functional block diagram of an example rental server that provides qualification searching and bidding for rental properties according to some embodiments of the present disclosure; and

FIG. 3 is a flow chart illustrating an example method of providing qualification searching and bidding for rental properties according to some embodiments of the present disclosure.

### DETAILED DESCRIPTION

A person interested in renting an apartment or other rental property (a “potential renter”) may have to manually search real estate listings to obtain the contact information of rental communities that have available rental units. The potential renter may then have to individually contact each of the rental communities to determine whether he/she is qualified to reside at the rental community (for example, due to his/her credit, income, rental history and/or criminal history), and if these available rental units are suitable for his/her needs/desires. Most rental communities limit the provision of rental property to only those persons meeting certain criteria established and set by the rental community. Thus, a potential renter may waste an inordinate amount of time contacting vendors (rental communities) that (i) do not have available rental units that match his/her needs and/or (ii) do not accept his/her circumstances and will therefore not lease to the potential renter because he/she is not “qualified” under the rental communities individual criteria. Additionally, a potential renter may spend unnecessary money paying application fees or the like to rental communities for which he/she is not qualified. Further, a potential renter may have to disclose embarrassing information (convictions, credit history, income, etc.) to persons at a rental community for which he/she is not qualified. In either case, the potential renter, when rejected, may have bad feelings about the rental community, which may be shared with friends or to the public, e.g., via social media. There are other disadvantages to a rental community as well. For example, the rental community may waste employee effort and time pursuing potential renters to which the rental community will not rent. This is a cumbersome and time-consuming process and leads to inefficiencies in the market for rental properties.

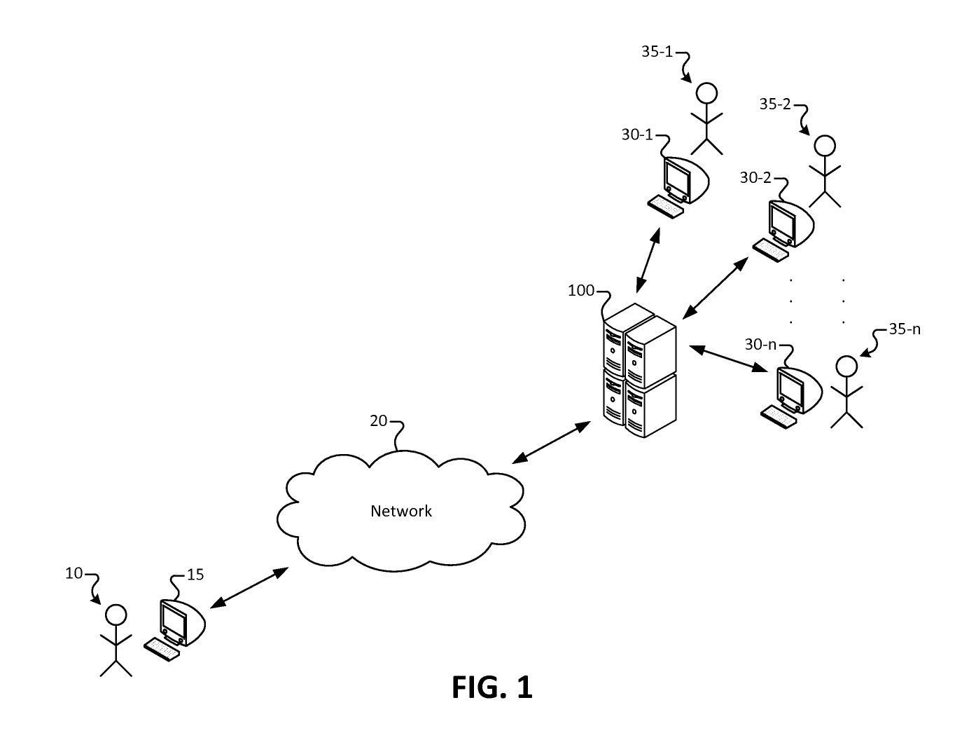

Referring now to FIG. 1, an example system for providing qualification searching and bidding for rental properties according to some embodiments of the present disclosure is illustrated. The example system provides an efficient process for matching vendors (e.g., rental communities) with consumers (e.g., potential renters). A potential renter, such as user 10, can utilize a user computing device 15 to access a network 20. The network 20 can include a wide area network (WAN) such as the Internet, a local area network (LAN), or a combination thereof. The network 20 can further be in communication with other computing devices, such as a rental server 100. The network 20 can permit the user computing device 15 to access and communicate with the rental server 100. The rental server 100 can further be in communication with a plurality of rental community computing devices 30-1, 30-2, . . . 30-n (collectively referred to herein as rental community computing devices 30) either through a direct connection (as shown) or through the network 20. Each of the rental community computing devices 30 can be associated with a rental community user 35-1, 35-2, . . . 35-n (collectively referred to herein as rental community users 35). It should be appreciated that the illustrated system is merely an example and the system can include additional or alternative components and still be within the scope of the present disclosure.

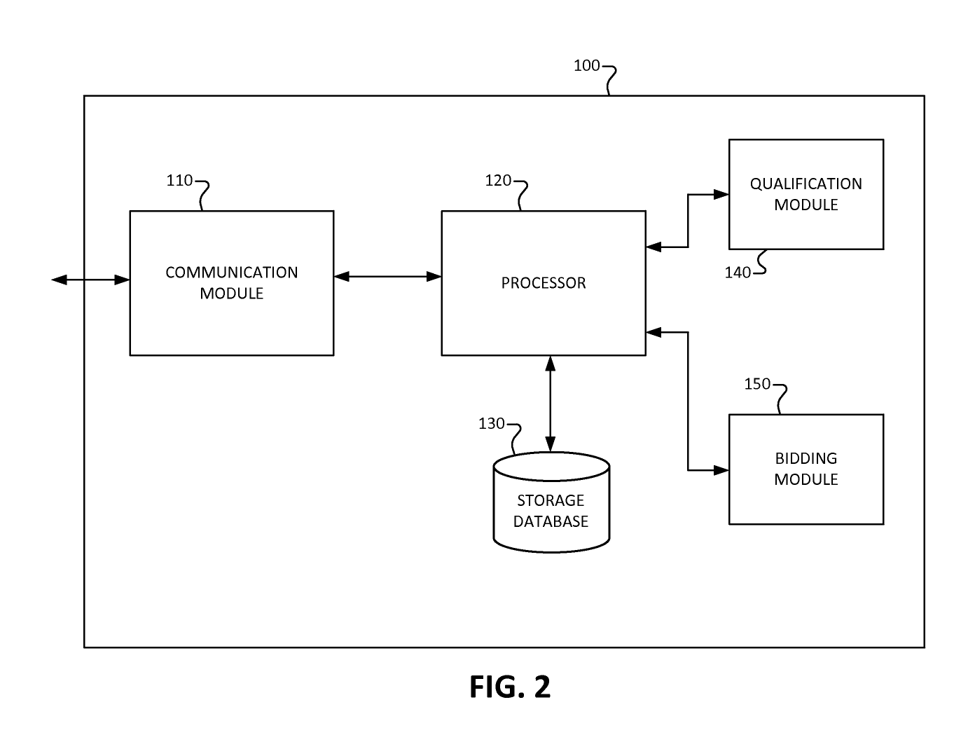

Referring now to FIG. 2, the rental server 100 can include a communication module 110, a processor 120, a storage database 130, a qualification module 140 and a bidding module 150. The communication module 110 can control communication between the rental server 100 and other devices. For example only, the communication module 110 may provide for communication between the rental server 100 and the user computing device 15 and/or the plurality of rental community computing devices 30-1, 30-2, . . . 30-n. The processor 120 can be configured to control the functionality of the rental server 20 by executing one or more software applications, such as the operating system of the rental server 100. Furthermore, the processor 110 can be configured to interact with some or all of the other components of the rental server 100, such as the storage database 130, the qualification module 140 and the bidding module 150, the functions of which are described below. While the communication module 110, the qualification module 140 and the bidding module 150 are illustrated as separate components from the processor 120, it should be appreciated that these components could be implemented at least in part by the processor 120.

As mentioned above, a rental community may determine a set of criteria which it requires any potential renter to meet in order to be considered as a future tenant. For example only, a rental community may require a potential renter to have a certain minimum income level, or a minimum credit score, in order to rent a rental unit. It should be appreciated that the term “credit score” can include an actual, single value credit score, as well as a range in which the actual, single value credit score falls and/or an average value/range of credit scores from different credit scoring agencies. In some situations, a rental community may also attach different conditions to a potential renter depending on the renter's qualifications. Furthermore, one rental community may have one set of qualifying criteria, while another rental community may have a different set of qualifying criteria. For example only, one rental community may require a potential renter to have a monthly income of 3× the monthly rent, while another, otherwise similar, rental community may require a potential renter to have a monthly income of 5× the monthly rent. In either of these two examples, a potential renter's qualifications may dictate the ability to “qualify” to rent from the rental community.

The qualification module 140 can be configured to perform a qualification search and matching method, as described more fully below. The rental server 100 can receive a user input corresponding to qualifications of the user 10 with respect to a rental property. For example only, the user 10 can provide answers to a plurality of questions presented on a web page accessed by the user computing device 15. The answers to the plurality of questions may form the basis for determining the qualifications of the user 10 to rent from a rental community. Example questions to which a potential renter's answers form the basis of his/her qualifications include (but are not limited to):

Are you legally able to rent an apartment?

Do you have a government issued picture identification?

Are you a first time renter?

Do you have any pet(s)? If yes,
a. How many Pets are living with you?

Will you be using a co-signer?
a. How many persons?
b. How much employment income for the co-signer(s)?
c. How much non-employment income for the co-signer(s)?

How many are applying for the rental? If multiple,
a. How many persons?
b. How much employment income for all lease signer(s)?
c. How much non-employment income for all lease signer(s)?

Do you have a valid government rent assistance voucher? If yes,
a. Voucher amount?
b. How many are applying for the rental?
c. How much employment income for all lease signer(s)?
d. How much non-employment income for all lease signer(s)?

Have you ever broken a lease? If yes,
a. How long ago?
b. Is there still a balance owed to that community?
c. Have you had positive rental history with another apartment community since then?

Have you ever been evicted? If yes,
a. How long ago?
b. Is there still a balance owed to that community?
c. Have you had positive rental history with another apartment community since then?

What is your credit score?

Have you ever had a foreclosure? If yes,
a. How long ago?

Have you ever filed for Bankruptcy? If yes,
a. How long ago?

How long have you been at your present job?

Have you or any future occupants ever been convicted of a crime against a person(s), property(s) or business(s) or animal(s)? If yes,
a. What type of conviction?
b. How long ago?
   It should be appreciated that additional or alternative questions to the above can be utilized. It should further be appreciated that the user 10 may establish his/her qualifications through a manner other than that described above.

In various embodiments, the qualification module 140 can determine the qualifications of the user 10 based on the information provided by the user 10 to the rental server 100. For example only, rather than receiving a credit score from the user 10 providing this information to the rental server 100 directly, the qualification module 140 may receive the credit score from a third party or service agency, such as a credit scoring agency. The rental server 100 may receive the user's full legal name and/or other identification information that uniquely identifies the user 10 (social security number, driver's license, etc.) as a portion of the qualifications of the user. This information can be provided to a credit scoring agency, which can provide the credit score of the user 10 to the rental server 100 (e.g., qualification module 140). The advantages of this process include the elimination or reduction of credit inquiries to different credit scoring agencies, which may negatively affect the credit score of the potential renter, since only one credit score inquiry needs to be to determine all rental communities for which the potential renter is qualified.

In yet another example, the qualification module 140 can determine the income level of the user 10 based on partial information provided to the rental server 100. For example only, rather than receiving a gross monthly income from the user 10, the qualification module 140 can receive an hourly wage, an approximate weekly hours worked, and/or other partial employment or non-employment (child support, government assistance, alimony, etc.) and calculate a monthly income for the user 10 to determine the rental community(ies) for which the user 10 is qualified. Additionally or alternatively, the qualification module 140 can determine a total monthly income for all potential renters (such as two or more roommates) for the rental unit based on similar information input. Typically, a rental community may base its qualification decision on the monthly income level of all potential renters compared to a multiple (3×, 5×, 6×, etc.) of the monthly rental price. In this manner, the qualification module 140 can do this comparison based on even partial information provided by the user 10. In the example in which a potential renter has a co-signer, a rental community may require a monthly income of the co-signer to be a higher multiple of the monthly rent than would typically be applied to a potential renter without a co-signer.

Upon receipt of user input corresponding to the qualifications of the user 10, the qualification module 140 can determine the rental community(ies) for which the user 10 would be qualified. This can be performed, e.g., by the qualification module 140 accessing a plurality of rental property records from the storage database 130. Each of the rental property records can correspond to the requirements of a particular rental community. For example only, the rental property records can be generated based on answers to a plurality of questions presented on a web page accessed by the rental community users 30 via the rental community computing devices 35. Example questions used to generate a rental property record for a rental community include (but are not limited to):

Do applicants have to be legally able to rent and apartment?

Do you require a valid government picture identification from applicants?

Do you accept first time renters?

What kind of pet(s) do you allow?

What type of community are you?

Do you accept co-signers?

How many multiples of monthly rent does a renter's income need to be?

Do you accept housing vouchers?

Do you accept broken leases?
a. Do you accept applicants with balances owed to other communities?
b. Do you require positive rental history since then from another apartment community?

Do you accept evictions?
a. Do you accept applicants with balances owed to other communities?
b. Do you require positive rental history since then from another apartment community?

What is the minimal credit score range you accept?

Do you accept foreclosures?

Do you accept bankruptcies?

What is the minimal time on job required to qualify?

Do you accept applicant(s) or occupants that been convicted of a crime against a person(s), property(s) or business(s) or animal(s)?
a. If so which type of convictions do you accept?
b. How old does the conviction need to be for an applicant to qualify?
   It should be appreciated that additional or alternative questions to the above can be utilized. It should further be appreciated that a rental property records can be generated in a manner other than that described above.

The qualification module 140 can determine one or more rental communities for which the user 10 would be qualified (“qualified rental properties”) based on the qualifications of the user 10 and the plurality of rental property records. For example only, the qualification module 140 can compare the qualifications of the user 10 with the plurality of rental property records to determine whether a user 10 “matches” or meets all of a rental community's criteria. In some embodiments, the qualification module 140 may match a user's 10 qualifications to a plurality of different qualification levels for each rental community, such as “well-qualified,” “qualified,” “may require additional deposits to qualify,” “deposits required to be qualified” and “not qualified.”

Additionally or alternatively, the qualification module 140 can determine a score for a user 10, the score being indicative of a user's 10 qualifications with respect to a rental property. For example only, each of user's 10 answers to the plurality of qualification questions can be assigned a number such that the user score is a mathematical combination (addition, average, mean, etc.) of all (or some) of those numbers. The score of the user 10 can be compared to a qualification threshold of each of the rental communities, e.g., stored in the rental property records at the storage database 130. Further, the score can be normalized to be a score between 0 and 1, or 0 to 100, such that the score of the user 10 can be expressed as a percentage match.

In some embodiments, and as described above, the qualification module 140 may match a user's 10 qualifications (such as by the user 10 score) to a plurality of different qualification levels for each rental community, such as “well-qualified,” “qualified,” “may require additional deposits to qualify,” “deposits required to be qualified” and “not qualified.” The qualification module 140 can determine one or more restrictions based on the score of the user 10 (or other form of the user's 10 qualifications). The restrictions can correspond to the conditions upon which a rental community will rent to the user 10. Example restrictions include, but are not limited to, a requirement and amount of a deposit to be paid by the user 10, the requirement of a co-signer of a rental agreement with the user 10, and a requirement of a down payment or payment of rent in advance. These restrictions can be provided to the user 10, e.g., on a web page generated by the rental server 100 and accessed by the user computing device 15 via the network 20.

In some embodiments, some of the user's 10 qualifications can be “matched” to the requirements of each of the rental communities, while others are assigned a number that are used to generate the score of the user 10 to be compared to the qualification thresholds of the rental communities. For example only, a specific rental community may not rent to someone convicted of a violent crime. Thus, any user 10 that has been convicted of a violent crime will not qualify to rent from that specific rental community. The specific rental community may, however, accept renters that have some combination of credit score and income level such that a user 10 that has a low credit score but a high income level (or a high credit score but a low income level) can qualify. By assigning a number to each of the credit score and the income level of the user 10, the qualification module 140 can determine a score of the user 10 (described above) that is compared to a threshold of the specific rental community to determine whether the user 10 is qualified.

In addition to the matching of the user's 10 qualifications to the requirements of each of the rental communities, the qualification module 140 can also perform a “match” of the needs/desires of the user 10 to the features of the rental communities. For example only, a user 10 may provide a user input to the rental server 100 that corresponds to at least one feature of a rental property desired by the user 10. The qualification module 140 can utilize this input to further determine (e.g., from comparison with the rental property records) which rental communities to include in the qualified rental properties to be presented to the user 10. Example features of a rental property include, but are not limited to, the number of bedrooms and/or bathrooms, the size (square footage) of the rental unit, the location (general or specific) of the rental unit, the minimum/maximum desired rental price, the minimum/maximum rental term, the floor of the building on which the rental unit is located, whether a doorman is present in the building in which the rental unit is located, the direction of exposure, the number of floors of the rental unit, the number of parking spaces included and whether the rental unit is furnished or not.

In various embodiments, the qualification module 140 can perform a multi-level matching method of the needs/desires of the user 10 to the features of the rental communities. For example only, a user 10 may provide a user input to the rental server 100 that corresponds to (i) at least one desired feature of a rental property desired by the user 10 and (ii) at least required feature of a rental property required by the user 10. A “desired feature” can correspond to a feature that the user 10 desires or prefers a rental property to have. A “required feature” can correspond to a feature that the user 10 needs a rental property to have in order for the user 10 to consider renting. The qualification module 140 can utilize this input to further determine (e.g., from comparison with the rental property records) which rental communities to include in the qualified rental properties to be presented to the user 10.

Upon determination of the one or more qualified rental properties, the rental server 100 can provide these qualified rental properties to the user 10, e.g., on a web page generated by the rental server 100 and accessed by the user computing device 15 via the network 20. Further information about the qualified rental properties can also be provided to the user 10, such as the number of bedrooms and/or bathrooms, the floor plan or other information related to the features of each qualified rental property. The user 10 can review the various rental properties for which he/she is qualified to determine whether the user 10 wants to bid on one or more of these qualified rental properties. The user 10 can select at least one of the qualified rental properties to bid on, for example only, by interacting with the web page. In this manner, the rental server 100 can receive a user input corresponding to this selection of at least one of the qualified rental properties to obtain one or more selected qualified rental properties.

Additionally, upon selection by the user 10 a rental community may be provided with a message that indicates that the user 10 is interested in possibly renting from the rental community. The message may include, for example, contact information for the user 10, as well as the qualifications determined by the qualification module 140. Similarly, the rental community may provide a response message to the user 10. After providing a message and/or a response message, a follow-up process may be implemented by the rental server 100. For example only, the rental server 100 may automatically send a reminder message (email, text message, telephone call, etc.) to the user 10 or the selected qualified rental property after a set period from the time of the message/response message. This follow-up process can ensure that both the user 10 and selected qualified rental properties have the opportunity to complete a rental transaction. For example only, the rental server 100 may follow up at 24 hours, 48 hours and 72 hours after providing a message/response. Additionally or alternatively, the rental server 100 may follow up at 6 months, 9 months and 12 months after providing a message/response. These monthly reminders may correspond to typical rental terms such that the rental server 100 can alert and remind the user 10 and/or selected qualified rental properties to contact the other party at the appropriate time to complete a future rental transaction. Further, these follow-up messages may be stored at the rental server 100 in order to allow the rental communities to track potential leads and the performance of its sales force.

The one or more selected qualified rental properties can be provided to the bidding module 150 to start a bid process. For example only, the user 10 can be provided with a web page that permits the user 10 to bid on renting one of the selected qualified rental properties. The user 10 can offer, for example, a rental bid that specifies a rental price, a rental term and other incentives, e.g., free covered parking or pool view) that can be accepted by the selected qualified rental properties. In some embodiments, the first selected qualified rental property to accept the rental bid of the user 10 can end the bidding process. In this example, the user 10 may be provided with the “winning” selected qualified rental property to complete the rental transaction (signing a lease, providing a deposit and rent, etc.). Additionally or alternatively, the “winning” selected qualified rental property can be provided with the user 10 information to contact the user 10 to complete the rental transaction. In these cases, the bidding process can be performed anonymously from the user 10 perspective, thus maintaining the privacy of the user 10 during the searching and bidding process.

In other embodiments, each of the selected qualified rental properties to accept the bid can be provided to the user 10 to complete the rental transaction. It should be appreciated that other forms of the bidding process are within the scope of the present disclosure, such as an auction format in which rental communities can provide multiple offers to underbid other rental communities such that the user 10 obtains the lowest cost rental. Furthermore, the user 10 (or the system itself) may set a time limit for the bidding process such that the user 10 and the rental communities can In some embodiments, the selected qualified rental properties can provide counterbids to the initial bid, which can be provided to the user 10 for acceptance or rejection. The counterbids can provide various rental offer details that differ from the original bid of the user 10. For example only, the counterbids can include a rental price, a rental term, and/or at least one additional incentive for the user 10 to sign a rental agreement with the rental community. Example additional incentives include, but are not limited to, a certain number of rent-free months/weeks/days, a free television or other furnishing(s), inclusion of a parking spot with the rental, and a gift card to a local or other merchant.

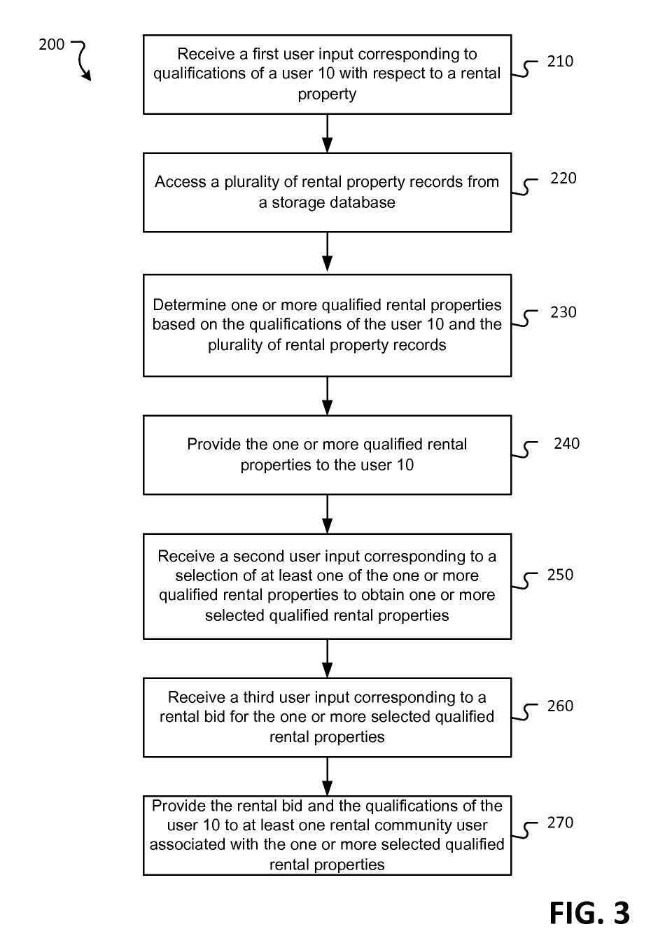

Referring now to FIG. 3, a flow chart illustrating an example method 200 of providing qualification searching and bidding for rental properties according to some embodiments of the present disclosure. At 210, the rental server 100 can receive a first user input corresponding to qualifications of a user 10 with respect to a rental property. At 220, a plurality of rental property records can be accessed from a storage database in communication with the rental server 100. The rental server 100, at 230, can determine one or more qualified rental properties based on the qualifications of the user 10 and the plurality of rental property records. As described above, the one or more qualified rental properties can correspond to rental properties for which the user 10 is qualified to rent based on the qualifications. At 240, the rental server 100 can provide the one or more qualified rental properties to the user 10. At 250, the rental server 100 can receive a second user input corresponding to a selection of at least one of the one or more qualified rental properties to obtain one or more selected qualified rental properties. At 260, the rental server 100 can receive a third user input corresponding to a rental bid for the one or more selected qualified rental properties. At 270, the rental server 100 can provide the rental bid and the qualifications of the user 10 to at least one rental community user 35-1, 35-2, . . . 35-n associated with the one or more selected qualified rental properties.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device, a first user input corresponding to qualifications of a user with respect to a rental property;
accessing a plurality of rental property records from a storage database in communication with the computing device;
determining, at the computing device, one or more qualified rental properties based on the qualifications of the user and the plurality of rental property records, the one or more qualified rental properties corresponding to rental properties for which the user is qualified to rent based on the qualifications;
providing, from the computing device, the one or more qualified rental properties to the user;
receiving, at the computing device, a second user input corresponding to a selection of at least one of the one or more qualified rental properties to obtain one or more selected qualified rental properties;
receiving, at the computing device, a third user input corresponding to a rental bid for the one or more selected qualified rental properties; and
providing, from the computing device, the rental bid and the qualifications of the user to at least one rental community user associated with the one or more selected qualified rental properties.

2. The method of claim 1, wherein the qualifications of the user include a credit score of the user.

3. The method of claim 2, wherein the user provides the credit score to the computing device.

4. The method of claim 2, further comprising:
providing, from the computing device, at least a portion of the qualifications of the user to a credit scoring agency; and
receiving, at the computing device, the credit score from the credit scoring agency.

5. The method of claim 1, further comprising receiving, at the computing device, a fourth user input corresponding to at least one feature of rental property desired by the user, wherein determining the one or more qualified rental properties is further based on the fourth user input.

6. The method of claim 1, further comprising determining, at the computing device, a score of the user based on the first input, wherein determining the one or more qualified rental properties includes comparing the score of the user to a threshold associated with each of the plurality of rental property records.

7. The method of claim 6, further comprising:
determining, at the computing device, one or more restrictions for each of the qualified rental properties based on the score of the user, the one or more restrictions corresponding to conditions upon which each of the one or more qualified rental properties will rent to the user; and
providing, from the computing device, the one or more restrictions to the user.

8. The method of claim 1, further comprising:
receiving, at the computing device, a counterbid from at least one rental community user associated with the one or more selected qualified rental properties; and
providing, from the computing device, the counterbid to the user.

9. The method of claim 8, wherein the counterbid includes a price and at least one additional incentive.

10. A computing system, comprising:
a storage database that stores a plurality of rental property records, each of the rental property records corresponding to one of a plurality of rental properties;
a processor in communication with the storage database and configured to receive a first user input corresponding to qualifications of a user with respect to a rental property;
a qualification module in communication with the processor and configured to determine one or more qualified rental properties based on the qualifications of the user and the plurality of rental property records, the one or more qualified rental properties corresponding to rental properties for which the user is qualified to rent based on the qualifications; and
a bidding module in communication with the processor and configured to:
(i) receive a second user input corresponding to a selection of at least one of the one or more qualified rental properties to obtain one or more selected qualified rental properties;
(ii) receive a third user input corresponding to a rental bid for at least one selected qualified rental property; and
(iii) provide the rental bid and the qualifications of the user to at least one rental community user associated with the one or more selected qualified rental properties.

11. The system of claim 10, wherein the qualifications of the user include a credit score of the user.

12. The system of claim 11, wherein the user provides the credit score to the processor.

13. The system of claim 11, wherein the processor provides at least a portion of the qualifications of the user to a credit scoring agency and receives the credit score from the credit scoring agency.

14. The system of claim 10, wherein the qualification module is further configured to:
receive a fourth user input corresponding to at least one feature of rental property desired by the user; and
determine the one or more qualified rental properties based on the fourth user input.

15. The system of claim 10, wherein the qualification module is further configured to:
determine a score of the user based on the first input; and
determine the one or more qualified rental properties by comparing the score of the user to a threshold associated with each of the plurality of rental property records.

16. The system of claim 15, wherein the qualification module is further configured to:
determine one or more restrictions for each of the qualified rental properties based on the score of the user, the one or more restrictions corresponding to conditions upon which each of the one or more qualified rental properties will rent to the user; and
provide the one or more restrictions to the user.

17. The system of claim 10, wherein the bidding module is further configured to:
receive a counterbid from at least one rental community user associated with the one or more selected qualified rental properties; and
provide the counterbid to the user.

18. The system of claim 17, wherein the counterbid includes a price and at least one additional incentive.

19. A computer-implemented method, comprising:
receiving, at a computing device, a first user input corresponding to qualifications of a user with respect to a rental property, the qualifications of the user including a credit score of the user;
determining, at the computing device, a score of the user based on the first input;
receiving, at the computing device, a second user input corresponding to at least one feature of rental property desired by the user;
accessing a plurality of rental property records from a storage database in communication with the computing device;
determining, at the computing device, one or more qualified rental properties based on the qualifications of the user, the second user input and the plurality of rental property records, the one or more qualified rental properties corresponding to rental properties for which the user is qualified to rent based on the qualifications, wherein determining the one or more qualified rental properties includes comparing the score of the user to a threshold associated with each of the plurality of rental property records;
determining, at the computing device, one or more restrictions for each of the qualified rental properties based on the score of the user, the one or more restrictions corresponding to conditions upon which each of the one or more qualified rental properties will rent to the user;
providing, from the computing device, the one or more qualified rental properties and the one or more restrictions to the user;
receiving, at the computing device, a third user input corresponding to a selection of at least one of the one or more qualified rental properties to obtain one or more selected qualified rental properties;
receiving, at the computing device, a fourth user input corresponding to a rental bid for the one or more selected qualified rental properties; and
providing, from the computing device, the rental bid and the qualifications of the user to at least one rental community user associated with the one or more selected qualified rental properties.

20. The method of claim 19, further comprising:
providing, from the computing device, at least a portion of the qualifications of the user to a credit scoring agency; and
receiving, at the computing device, the credit score from the credit scoring agency.
